(19) United States
(12) Patent Application Publication
(10) Pub. No.: US 2008/0167737 A1
(43) Pub. Date: Jul. 10, 2008

(54) Golf Scoring System and Method

(76) Inventor: Steve SCHMIDT, Chicago, IL (US)

Correspondence Address: BEEM PATENT LAW FIRM, 53 W. JACKSON BLVD., SUITE 1352, CHICAGO, IL, 60604-3787, US

(21) Appl. No.: 11/619,966

(22) Filed: Jan. 4, 2007

(51) Int. Cl. G06F 19/00

(52) U.S. Cl. 700/92

(57) ABSTRACT

A system for administrating tournaments and rounds, includes an automated server that collects tournament, round, player, score and statistic information, e.g., for golf, via text communication, and calculates and distributes standings, rankings, and points data derived from, the information to players and spectators via text communication. A text communication device accepts input of information to be collected by the automated server and sends the information to the automated server in a text communication format. The automated server distributes the data derived from the information to the text communication device via text communication, so that collection and distribution of information and data occurs in a near-real-time fashion via commonly available text communication methods.

### BACKGROUND OF THE INVENTION

1. Field of the Invention

This invention relates to methods for providing a scoring and standings system via commercially available text communication methods for golf tournament and round play.

Golf tournament and round players are not able to easily calculate, rank, share, etc. golf score, statistic, and standing information during play. Golf tournament and round organizers must manually collect, organize, record, and distribute scores, statistics, and standing information after play. Scoring is subject to improper collection and inaccurate calculations due to human error. Golf tournament round organizers must calculate handicaps prior to and in between rounds. Organizing players into groups for future rounds becomes manually intensive when there is a need to place players in groups based on handicap, previous scoring, current rank in tournament, round robin, or random calculations. This becomes troublesome and time consuming, especially during tournaments and multiple round play.

Existing “real-time” play solutions require players to enter scores into a device that communicates that input through wireless Internet communication methods to a central communications center via direct point-to-point protocol technology. These devices and services are expensive to own and use, therefore, are not feasibly available to most people. Also, if a wireless Internet communication with direct point-to-point protocol access is not available, then “real-time” play is not available.

The Internet and Electronic Messaging have permitted users to easily exchange information over the Internet. Plus the emergence and availability of text communication messaging via wireless devices permit nearly constant access to text information exchange channels via commercially available communication networks. Golf scores and statistics, for example, may be collected and distributed via these text communication channels for near real-time exchange of information. The collection and distribution of this information can be provided by an Automated System to ensure accurate calculations and timely distribution.

2. Description of the Related Art

Handegolf (www.motherhensw.com)—Must use PalmOS software with or without wireless. Without wireless requires data upload after round. Requires point-to-point protocol synchronization.

Escorecard (www.escorecard.co.uk)—Not Real-time; enter scores in Palm, then synchronize to PC. Requires point-to-point protocol synchronization.

EgolfScore (www.egolfscore.com)—Must download Java application and must have a device containing this Java application in each group. This solution provides a very “user friendly” interface to tournament setup and scoring. At time of research, has a 20 player limit unless the event is hosted by the service provider. Requires point-to-point protocol synchronization.

eGolfScore's Event Scoring Program (eSP) provides wireless scoring and real-time leaderboards for golf outings. Each foursome enters their scores using a handheld device. At any time during the round, they can view a real time leaderboard on the device. This leaderboard can also be viewed on a TV in the clubhouse and live on he internet. eGolfScore provides all of the equipment and staff needed for the day. Requires point-to-point protocol synchronization with proprietary methods for data synchronization.

Golfing Source (www.golfingsource.com)—Web based only for analysis. Not real-time game tracking & handicapping.

Multiple Sites (http:www.programurl.com/golf-tournament-scorekeeper.htm)—Web based only for analysis. Not real-time game tracking & handicapping.

Golf Score Central (http:/www.golfscorecentral.com/wireless.htm)—Proprietary tournament system. Company must host the event and they bring their own equipment.

GPS Golf Vision (vww.gpsgolfvision.com)—Proprietary devices that are either mounted on a cart or distributed by the clubhouse. These are typical GPS & scoring devices. Requires golf course participation.

@IntelliGolf Par/Palm OS (http:/www.handheldnews.com/file.asp?ObjectID=5724)—Must use Palm device. Scoring and analysis. Wireless capability allows for the download of courses. Requires point-to-point protocol synchronization using proprietary methods for scoring input and results distribution.

IntelliGolf (http://www.intelligolf.com)—Keeps scores & stats for up to five players. Does not share scores with other during play. Use wireless for access to course downloads and GPS.

### SUMMARY OF THE INVENTION

This invention relates to an automated system and business process that collects scores and statistics from golfers and distributes those results to other golfers within a defined tournament or round. The exchange of this information occurs via commercially available text communication exchange methods. This exchange can occur in near real-time to allow golfers to identify standings (either by score or points) as compared to all players in the tournament or round. This invention also allows a tournament administrator to set scoring and/or point rules for overall scoring. Additionally, secondary games can be created to allow scoring and/or point rules that may include all or a subset of tournament and round players. Tournament settings allow for the system to change the rank of players based on a handicap system from round to round. Historical scores and statistics are recorded and made available by tournament, round, or player. These historical scores and statistics can be automatically applied to future rounds and tournaments for handicap calculations, group and team pairings.

In accordance with one aspect of the invention, a system for administrating user preferences, capabilities, and subscription, comprises an automated server that collects information via text communication, and calculates and distributes data derived from said information via text communication, a text communication device that accepts input of information to be collected by said automated server and sends said information to said automated server in a text communication format; said automated server distributes said data derived from said information to said text communication device via text communication, so that collection and distribution of information and data occurs in a near-real-time fashion via commonly available text communication methods.

In accordance with another aspect of the invention, a system for administrating tournaments and rounds, comprises an automated server that collects tournament, round, player, score and statistic information., e.g., for golf, via text communication, and calculates and distributes standings, rankings, and points data derived from said information to players and spectators via text communication; a text communication device that accepts input of information to be collected by said automated server and sends said information to said automated server in a text communication format; said automated server distributes said data derived from said information to said text communication device via text communication, so that collection and distribution of information and data occurs in a near-real-time fashion via commonly available text communication methods.

These and other features and advantages are evident from the following description of the present invention, with reference to the accompanying drawings.

### BRIEF DESCRIPTION OF THE SEVERAL VIEWS OF THE DRAWINGS

FIG. 1 is a system diagram, showing a system used during tournament setup, that shows gui & text communication interfaces.

FIG. 2 is a system diagram, showing a system used during tournament play, that shows only Text Communication Interfaces are available for input & output

FIG. 3 is a screenshot of a mobile, wireless device indicating the arrival of a new message.

FIGS. 4A and 4B are screenshot examples of a tournament players list.

FIGS. 5A and 5B are screenshot examples of a registered scorekeeper request message.

FIG. 6 is a screenshot example of a registered scorekeeper reply message.

FIG. 7A and 7B are screenshots of a group start message for round 1 & group 1.

FIG. 8 is a screenshot of a score input for hole #1.

FIG. 9 is a screenshot displaying sending a message to record scores for hole #1.

FIG. 10 is a screenshot of an input score reply message for hole #1.

FIG. 11 is a screenshot of a score input for hole #2.

FIG. 12 is a screenshot displaying sending a message to record scores for hole #2.

FIG. 13 is a screenshot of an input score reply message for hole #2.

FIG. 14 is a screenshot of a score input for hole #3.

FIG. 15 is a screenshot displaying sending a message to record scores for hole #3.

FIG. 16 is a screenshot of an input score reply message for hole #3.

FIG. 17 is a screenshot displaying resending a message to correct scores for hole #3.

FIG. 18 is a screenshot of a corrected score reply message for hole #3.

FIG. 19 is a screenshot of an input & reply message for hole #18.

FIGS. 20A and 20B are screenshots of round results for the individual stroke game.

FIGS. 21A and 21B are screenshots of round results for the individual skins game.

FIGS. 22A and 22B are screenshots of a group start message for group 1 in round 2.

### DETAILED DESCRIPTION OF THE INVENTION

With the system/method of the invention golf tournament and round scores, statistics, and standings can be entered by players in real-time during play. Golf tournament and round scores, statistics, and standings are automatically calculated and distributed in real-time to players and spectators. This includes calculations for applying handicap settings and game type specifications to scores, statistics, and standings prior to distribution. Golfer handicaps are automatically calculated between rounds and automatically applied to future rounds.

The system allows for automatically creating golf pairings and groups based on factors like handicap, scoring, rank, round robin, or random. Golfer standings, statistics, and scores can be calculated in whole or in part over multiple rounds within a tournament or outing. The disclosed system and method uses commonly available wireless text communication methods provided by commercial wireless providers to communicate to a central communications center. In many cases, these text communication methods do not rely on Internet connection capabilities to the user CPE or handset. Many commercially available text communication methods rely solely on switching techniques in cellular technology.

Text communication methods provided by commercial wireless providers are more commonly available than media connections and direct point-to-point Internet protocol connections. The disclosed system and method allows “real-time” play to be more widely available. Golfers and spectators can receive real-time scoring, statistics and standings on wireless devices via these commonly available text communication methods. Scoring, statistics, and rankings can be calculated automatically and more accurately. Historical data from previous rounds can be automatically applied to future rounds grouped into a tournament or outing. Players will be able to view scores, statistics, and standings in a real-time fashion from all players during a tournament or round. Players will be able to compete real-time with all players in a tournament or round during play. Tournament and round organizers will be able to perform many, if not all, administration tasks prior to play.

This reduces the amount of administration that needs to be done after play or between rounds. The disclosed system and method offer improved accuracy of data, time investment is reduced to minimize data gathering, reconciliation, and manipulation and to maximize every player's experience. Standard gaming methodology reduces training time from tournament to tournament, all players see the same information immediately. Immediate knowledge of ranks enhances the immediate satisfaction of “braggin' rights” (e.g., playing into the competitive nature of the people that play such games.)

### Glossary of Terms

Commercially Available Text Communication Method—Method provided by third party companies that allow for the exchange of text communications.

CPE—Customer Premise Equipment. A wired or wireless device either owned or rented by the customer that provides access points to analog and digital communications.

Electronic Messaging—any message transmitted through an electronic media via a text communications accessible device. Includes email, text messaging, and instant messaging.

GUI Communication Method—Graphical User Interface method that allows for pictorial presentation, selection and input. Normally presented through a web page for access on an Internet Accessible Device.

Handicap—Feature of the golf scoring system that allows players of various skill levels to compete at similar levels.

Internet—The interconnection of computers and networks around the world that provide for access to sharing and distribution of information from a number of different access points.

Internet Accessible Device—A device that provides either wireless or fixed point wired access to the Internet or private Internet Protocol Network. Common devices include personal computers (PC), laptop computers, personal data assistants (PDA), cell phones, pagers, and 2-way pagers.

ISP—Internet Service Provider. Provides access services to the Internet

Online Access—A method of accessing Internet content through a constant connection via and Internet Accessible Device. Typical connections include viewing of web page content.

Player—Golfer who participates in a tournament or round.

Point-to-Point Protocol—Transmission of data between two system end points that rely on direct end-to-end communication using Internet Protocols.

Real-Time—Actions that occur simultaneously with events. For example, players entering scores during play at the completion of a hole.

Round—A game of golf that consists of playing a set number of holes (typically 18 holes) on a single course.

Scoring and Points—Competition measurement for players in a tournament or round. Scoring can be set based on stroke or matched play with or without handicap as an example. A point system can be set based on statistics or scores beyond basic scoring. Points can be based on competitive games such as skins, greens hit in regulation, scores that include sand shots, score differential, head-to-head, team match play, etc.

Secondary Games—Additional competition games within a tournament or round that may consist of different scoring and point systems and may include all or a subset of tournament and/or round players.

Spectators—A person who watches or tracks players during a round.

Tees—Point where players start play on a hole. A single course typically has multiple sets of tees that denote the skill level of players based on distance and difficulty.

Text Communication Method—A simple text only method of communication consisting only of alphanumeric characters, plus symbols and spaces. Typically relies on “store and forward” technology for message distribution.

Tournament—A collection of rounds that consists of the same set or subset of players.

Tournament Captain—User who manages a tournament or round. Responsible for specifying game type, scoring type, players, options, etc. for a tournament or round,

User—Customer that interacts with this system via any of the available access methods.

### Overview

The invention provides an automated system that allows for “any-time” setup, entry, and distribution of scoring and statistics, plus access to historical scoring and statistics, for golf tournaments and rounds. A tournament captain sets up tournament and rounds by specifying game type, scoring type, course information, and the list of player participants in an application referred to tournament manager. Players can administer individual player information (name, input preferences, addresses, etc.) via an application referred as player manager. Individuals and tournament captains can administer course information (name, slope, rating, handicap, tees, yardage) via an application referred as course manager.

The system provides methods for tournament and round setup; a centralized collection of data with acknowledgement of receipt and accuracy; and a distribution of standings and statistics. The system also provides for the following:
Calculation of scoring and points based on tournament and round setup
Calculation of player handicap and ranking for use across multiple tournaments and rounds.
Recording and reporting of tournament, round, player, and course history
Setup, input, and retrieval of scoring, points, statistics, and history via text communication methods
Setup of new tournaments and rounds, plus input and retrieval of historical scoring, points, and statistics via GUI communication methods

This system replaces the need for manual collection and administration of tournament scoring, statistics, and calculations. This system also provides for “any-time” scoring access for tournament players and spectators via any text communication accessible device, thus allowing players access to scoring, statistics, and points during play or near real-time following play.

This system leverages input methods via commercially available text communication methods, including email, text messaging, and instant messaging, for collecting scoring and statistics. Standard score and statistic input methods are distributed to players with input capabilities prior to play. Standard methods and procedures for retrieving player scores, statistics, points, and standings are also distributed to players and spectators with retrieval capabilities.

The system/method of the invention supports the following features utilized to provide an automated system for “any-time” golf scoring and statistics: administrating user preferences, capabilities, and subscription; text communication device preferences and capabilities; subscription and membership descriptions and signup, and user member id and password maintenance; administrating tournaments and rounds including access though cell phone, PDA, laptop, or other mobile device via electronic messaging or device via web page access, or access though wireless phone via an interactive voice response system, and inviting registered players to join tournaments and rounds

Tournament specifications may include the following: number of rounds, number of players, rules to qualify for additional rounds, starting player handicaps & weight for future round calculation, slope & rating for each course & tee combination to be played, par, distance, and handicap for each hole, multiple round handicap calculation (i.e number of recent rounds to use, weight for each round, etc.), player pairing and group assignment rules (i.e. order of handicap, random, previous scoring, selective random, etc.), player tee assignments and rules for assigning different tees in future rounds, tournament identifier for input & reporting devices, round identifiers for input & reporting devices, player identifiers for input devices, and input message and request message options.

Round specifications may include the following: game type (skins, stroke, match, cup, etc. format), scoring type (strokes, match play, point system, etc), player pairings, player groups.

Recording player scores and statistics during play may include: access though cell phone, PDA, laptop, or other device via text communication messaging; access though wireless phone via an Interactive Voice Response system.

Scores & statistics may include the following for each hole played: individual score, team score, fairway hit, number of putts, hit green in regulation, number of sand strokes, drive distance, distance from hole with approach shot to green, and list of scores and statistics for multiple players with a group.

Distributing tournament and round statistics and standings during play may include: access though cell phone, PDA, laptop, or other device via text communication messaging; access though wireless phone via an interactive voice response system; round statistics and standings requests; player settings for automatic retrieval of statistics and standings, and retrieval of statistics and standing by request

Round statistics and standings requests may include the following for tournaments and rounds: leader board by number of strokes with and without handicap, leader board by number of points, statistics and standings for all holes played, or only through a specified number of holes based on the number of holes that have been played by the requesting player.

The system will provide security for access and input to tournament and round information and data. Levels of security will be set for system administrators, tournament & round administrators, scorekeeper players, score receiver players, and spectators. The system will provide security levels to allow golf courses and clubs to administer and maintain tournaments & rounds at their facilities. The system will provide a method that will record tournament, round, and player scoring and statistics for historical retrieval purpose.

### EXAMPLE

### Golf Scoring System Demonstration

### Overview

### Purpose

This example illustrates a demonstration of a Golf Scoring System (referred hereafter as the “System”). The System is used for automated tracking and calculation of golf scores and side game scores for multi-player tournaments.

### Scope

The demonstration contained in this example addresses the setup of a tournament, including round, player, and course specifications. This demonstration also addresses the input process for exchanging scores and other information with the System using text communication messages. This demonstration assumes that the audience is knowledgeable of basic tournament and round play and scoring for golf, as well as common competitive games such as stroke play, match play, best ball, scramble, skins play, etc.

### User Interaction Methodologies

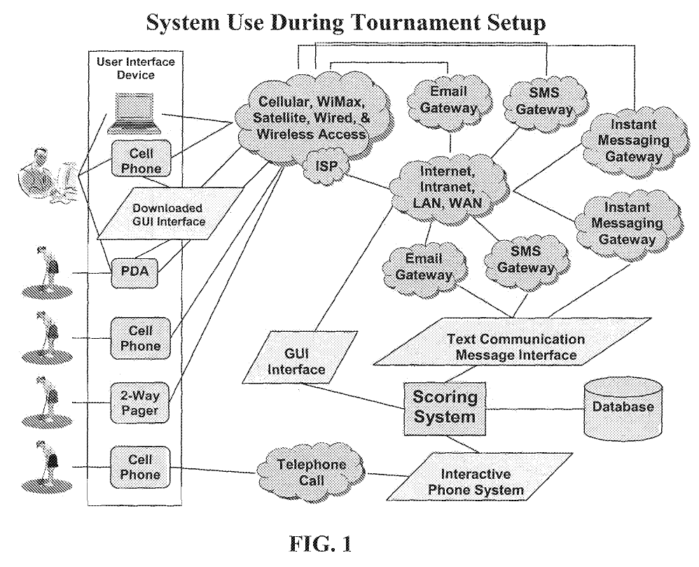

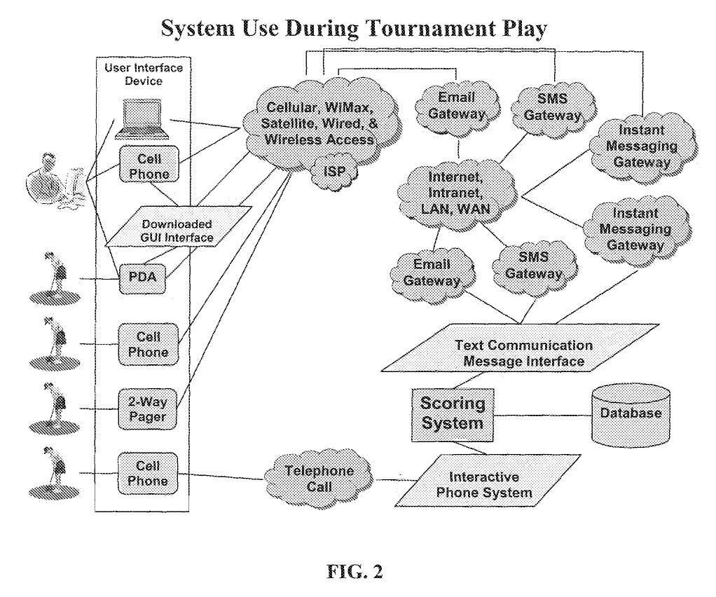

The tournament setup steps in the system are accomplished via commonly available web portal, wireless access protocol, and text communication interface tools. Player interaction of the system during play occurs via commonly available text communication methods. In this regard, FIG. 1 is a system diagram, showing a system used during tournament setup, including GUI & text communication interfaces. FIG. 2 is a system diagram, showing a system used during tournament play, which uses text communication interfaces for input & output.

This demonstration uses email over text messaging as the text communication interface for player input. The device used is a wireless handset that provides text communication through a wireless service provider. Screenshots from this wireless handset are included in this demonstration. This text communication interface is available through most wireless service provider companies and most end user devices compatible with service provided by these companies.

### Use Case & Example Flow

This demonstration portrays an example where 8 people play a tournament consisting of 2 rounds. Each round consists of 2 foursome groups that play competitive games against all 8 players in the tournament. The competitive games for the demonstration are individual scores, with handicap, based on a total net score after each round is complete. Players earn points based on a finish in first, second, or third place in a single round. A skins game is also played with the net scores from each hole. Points are allotted to the skins game for a round, which are divided equally across the total number of skins that are won in the round.

The System is used to allow the players to immediately see game standings during the progression of the rounds in the tournament. A Tournament Captain would use the system to setup a tournament, select any number of available System games, and register tournament players prior to the start of play. Also prior to play, the Tournament Captain would identify certain players as Registered Scorekeepers. As the golf round progresses, a Registered Scorekeeper person from each group would send a text communication message with the scores for the group. The System sends a reply message to the Registered Scorekeeper with the current game standings based on input from all groups.

Key actors in this scenario are:
The Tournament Captain—Responsible for setting up the tournament and allows other Tournament Players to become Registered Scorekeepers. The Tournament Captain can also be a Tournament Player and a Registered Scorekeeper.
The Tournament Players—Golfers that participate in the tournament. A Tournament Player can also be a Registered Scorekeeper
The Registered Scorekeepers—Responsible for entering the scores for a group during play. The Registered Scorekeepers also receive current game standings from the System and are Responsible for sharing those standings with the other players in the group.

### Demonstration Use Cases—Tournament Setup

As mentioned in the Overview section, a Tournament Captain would access the System to create a tournament consisting of one or more rounds of golf and the setup details of each round in the tournament. To do this, a Tournament Captain would access a website or text communication device to setup the tournament. This interface would allow the Tournament Captain to define a tournament by specifying rounds, players, courses, groups, games, etc.

In this demonstration, the Tournament Captain is identified as “Steve Schmidt”, who has access to the System with permission to create and setup a tournament. The Tournament Captain creates a tournament consisting of two rounds of golf. The tournament setup referenced in this demonstration is provided in the spreadsheets in Table 1 through Table 5 and explained in the text that follows.

### Tournament Creation

The first step of the tournament setup requires the Tournament Captain to enter a tournament name and a tournament password to declare a new tournament. This information is used to uniquely identify the tournament in the System. The tournament name and password for the demonstration in the document are shown in Table 1.

TABLE 1
Tournament Creation Information

| Tournament Name | Tournament Password |
|---|---|
| PatentDemo | mytourney |

Table 1 shows that the tournament has been given a name of “PatentDemo” with a tournament password of “mytourney”. This information can be used for additional tournament setup as discussed later in this document.

### Course Specification

Once the tournament is created, the additional steps can occur to continue the tournament setup. The next step listed for the demonstration in this document is to specify the Course detail information. The Course setup information is shown in Table 2.

TABLE 2
List of Tournament Courses

| | | Hole | | |
|---|---|---|---|---|
| Round | Course Name | Number | Par | HDCP |
| Round 1 | My Course #1 | 1 | 4 | 11 |
| | | 2 | 4 | 17 |
| | | 3 | 5 | 9 |
| | | 4 | 3 | 13 |
| | | 5 | 4 | 1 |
| | | 6 | 4 | 7 |
| | | 7 | 4 | 3 |
| | | 8 | 3 | 15 |
| | | 9 | 5 | 5 |
| | | 10 | 4 | 2 |
| | | 11 | 3 | 18 |
| | | 12 | 4 | 14 |
| | | 13 | 4 | 10 |
| | | 14 | 4 | 12 |
| | | 15 | 5 | 6 |
| | | 16 | 3 | 16 |
| | | 17 | 5 | 8 |
| | | 18 | 4 | 4 |
| Round 2 | My Course #2 | 1 | 5 | 7 |
| | | 2 | 4 | 17 |
| | | 3 | 4 | 9 |
| | | 4 | 4 | 5 |
| | | 5 | 3 | 1 |
| | | 6 | 5 | 11 |
| | | 7 | 4 | 3 |
| | | 8 | 3 | 13 |
| | | 9 | 4 | 15 |
| | | 10 | 4 | 10 |
| | | 11 | 4 | 4 |
| | | 12 | 3 | 14 |
| | | 13 | 5 | 2 |
| | | 14 | 4 | 12 |
| | | 15 | 4 | 6 |
| | | 16 | 5 | 18 |
| | | 17 | 3 | 8 |
| | | 18 | 4 | 16 |

The Course information in Table 2 shows that two golf courses will be played in the tournament. The input must include the course name that will be played for each round of the tournament and the number of holes with par and handicap for each hole. Other specific detail could include but are not limited to tee boxes played, handicap variations by tee box, and course slope and rating information.

### Round Tee Times

Tee times are specified for each group in every round to allow for appropriate timed tournament and group start messages to be sent to the Registered Scorekeeper of each group. These times are displayed in Table 3.

TABLE 3
Round Tee Times

| Round | Group | Tee Time |
|---|---|---|
| Round 1 | Group 1 | 9/5/2006 2:00 PM |
| Round 1 | Group 2 | 9/5/2006 2:08 PM |
| Round 2 | Group 1 | 9/6/2006 8:34 AM |
| Round 2 | Group 2 | 9/6/2006 8:42 AM |

Table 3 shows that Round 1 is being played by both groups on Sep. 5, 2006. Group 1 starts at 2:00 PM and Group 2 follows at 2:08 PM. Round 2 is played the following day on Sep. 6, 2006 at 8:34 AM and 8:42 AM for Group 1 and Group 2, respectively.

### Tournament Round Games

Next, the list of games being played in each round for the tournament is specified. For each game, the tournament captain enters the leaderboard places that will be considered “winners” for each game, along with a point distribution. These points will be recorded for each round and summed at the end of the tournament to determine an overall tournament leaderboard. Table 4 shows the round games and point distribution for the demonstration tournament.

TABLE 4
Round Game Specification

| | | | | Use |
|---|---|---|---|---|
| Round | Game Type | Finish Place | Points | Handicap |
| Round 1 | Individual Stroke | 1 | 40 | Y |
| Round 1 | Individual Stroke | 2 | 25 | Y |
| Round 1 | Individual Stroke | 3 | 15 | Y |
| Round 1 | Individual Skins | 1 | 80 | Y |
| Round 2 | Individual Stroke | 1 | 40 | Y |
| Round 2 | Individual Stroke | 2 | 25 | Y |
| Round 2 | Individual Stroke | 3 | 15 | Y |
| Round 2 | Individual Skins | 1 | 80 | Y |

The table in Table 4 shows that each round consists of individual stroke and individual skins games. Players can receive points for finishing in the first three places in the individual stoke games in each round. For the individual skins game, the total allotment of 80 points will be divided across all skins won in each round. This table also specifies that all games will use net handicap scores for game standings calculation.

### E. Player Identification

The next step in the tournament setup process is to specify players to play in the tournament. The Tournament Captain adds the list of players to the tournament created in the first step. Table 5 shows the players that will participate in the demonstration in this document.

TABLE 5
List of Tournament Players

| Player Number & | Player | Starting | | | Tournament | Registered |
|---|---|---|---|---|---|---|
| Name | Display | Handicap | Round 1 | Round 2 | Captain | Scorekeeper |
| 1-Steve Schmidt | SR | 9 | Group 1 | Group 1 | X | X |
| 2-Martha Johnson | MJ | 18 | Group 1 | Group 2 | | |
| 3-Teddy Roosevelt | TR | 3 | Group 1 | Group 1 | | |
| 4-Sam Duke | SD | 6 | Group 1 | Group 2 | | |
| 5-Larry Wright | LW | 15 | Group 2 | Group 1 | | |
| 6-John Adams | JA | 12 | Group 2 | Group 2 | | |
| 7-George Washington | GW | 9 | Group 2 | Group 1 | | |
| 8-Thomas Jefferson | TJ | 1 | Group 2 | Group 2 | | X |

The setup information in Table 5 lists the eight tournament players by specifying the player's full name and the shortened display name. The shortened display name is used for text communication messages where display space is limited. Each player's starting handicap is added to allow the tournament to calculate standings based on handicapped net scores. Also specified during tournament setup is each player's group assignment for each round and player assignments as Registered Scorekeepers. Care must be taken to ensure that a Registered Scorekeeper is present in each group for every round in the tournament. The Tournament Captain “Steve Schmidt” is also listed.

### Registering a Device for Text Communication Messaging

The final step in the tournament setup process is for the Tournament Captain to register a device for text communication messaging with the System. This process allows the Tournament Captain to interact with the system using a device that is easily accessible during and immediately prior to play. This device text communication interface provides the access for the Tournament Captain to further define System setup and allow the Tournament Captain to act as a Registered Scorekeeper.

For this demonstration, the Tournament Captain “Steve Schmidt” would create a contact in his wireless device for the System's input email address. The name given for the contact in this demonstration is “Zzz goscores” and it is associated with an email address of “goscores@srocktech.com”. The contact name starts with “Zzz” so that it will be placed at the bottom of the contact list, therefore, easy to find during play.

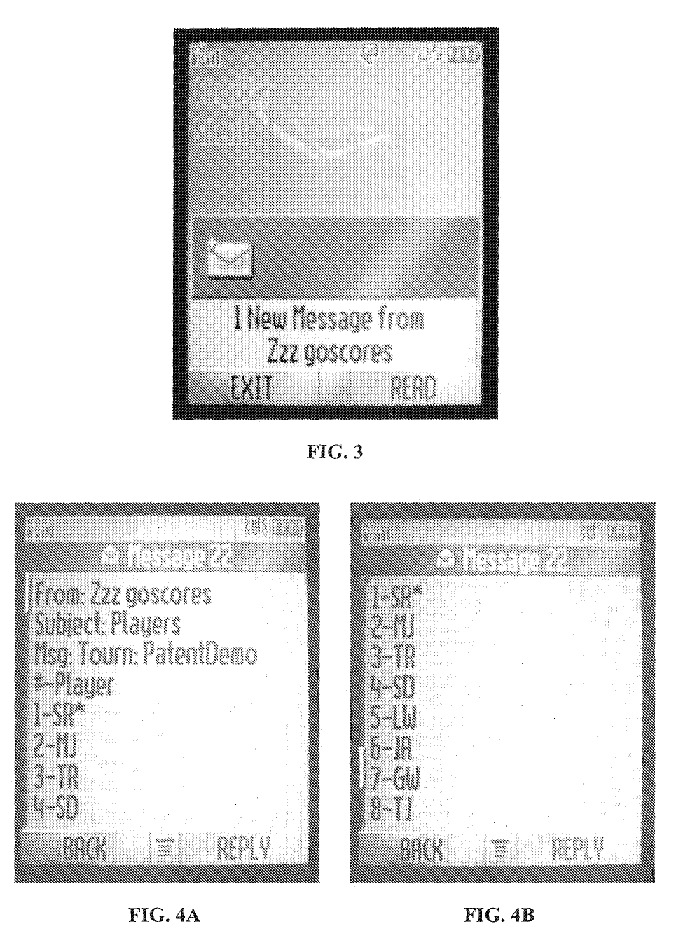

After this contact is created, messages that arrive to the registered device will display the name entered for the contact. A screenshot example is displayed in FIG. 3 showing the demonstration device screen when a new message has arrived.

It is recommended for ease of use that the Tournament Captain and all Registered Scorekeepers create a System contact on his or her wireless access device. This contact will reference the text communication address of the input account for the System.

The Tournament Captain would then enter the text communication address of his or her wireless access device through the System setup interface. Once this is complete, the System identifies this text communication address as the Tournament Captain. Only messages from this address are allowed to modify tournament settings. The System will also send tournament messages to this address for receipt by the Tournament Captain.

### Demonstration Use Cases—Device Registration

Prior to the start of the first round of the tournament, a message is sent to the Tournament Captain's registered device. This message lists all of the players in the tournament with each player's corresponding Tournament Player Number. The information in this message is used to supplement the tournament setup. An example of this message is displayed in FIGS. 4A and 4B.

The Tournament Captain can use this message to assign additional Registered Scorekeepers to the tournament. Registered Scorekeepers will then send a message to the System to register their mobile device for input to the System.

This event establishes a communication path to the System for the exchange of information based on the sender's text communication address (text message number, email address, etc.) The registration message includes the information needed to allow the System to associate the text communication address of the registered scorekeeper's device with the player specified in the tournament setup.

The registering player sends a message to the System that includes:
The Registration Key Word
Tournament Name
Tournament Password
The Player's Tournament Player Number.

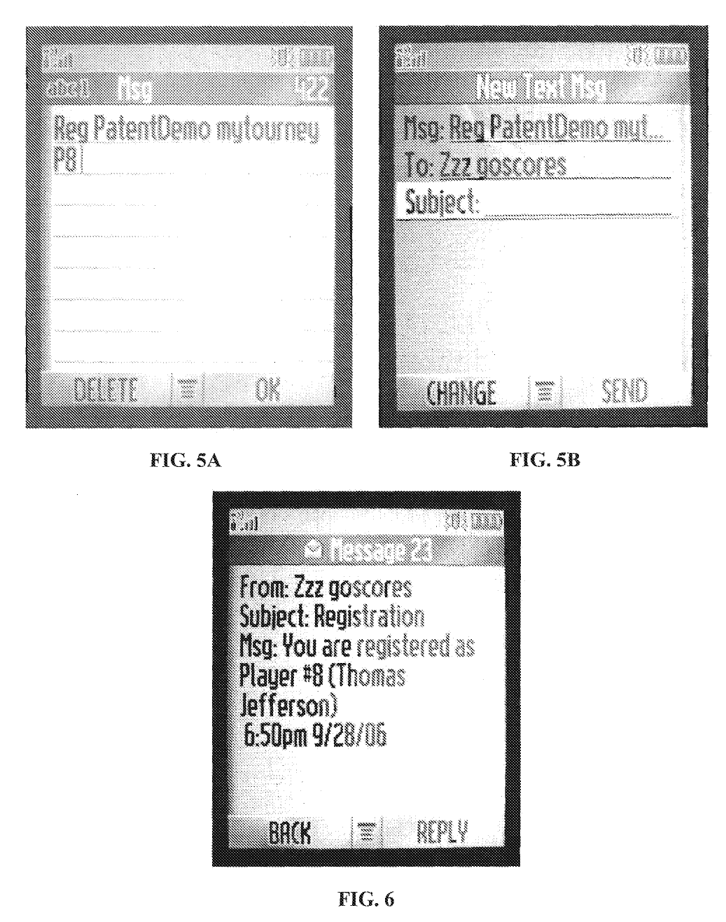

A screenshot example of this message is displayed in FIGS. 5A and 5B. The example text communication message contains the text “Reg PatentDemo mytourney P8”.

The System receives the message and can then link the sender's email address with the tournament player's number to identify him as a Registered Scorekeeper. Note that the example in this demonstration shows the “Reg” key word for the action along with the Tournament Name of “PatentDemo” and password of “mytourney”. This action registers Player #8, Thomas Jefferson, as an additional Registered Scorekeeper. The System sends a reply message signaling the successful registration. An example of this reply is displayed in FIG. 6.

The System is able to use the setup information to know the groups within each round of the tournament where this player will participate. After this registration, the player can maintain the two-way communication with the System by always sending messages from his registered email address. Additional uses for the tournament player list message include but are not limited to: moving players between groups, changing player names and display values, adjusting starting handicaps. All of these uses require System interaction similar to the process for assigning additional Registered Scorekeepers. Each requires the specification of the action key word along with the data to support the action.

### Demonstration Use Cases—Tournament Start

After the setup for the tournament is complete, the System will send a pre-round message with an attached spreadsheet to the Tournament Caption showing the setup for the first round. The System can automatically generate handicaps based on data input from previous rounds and tournaments. Handicap calculations are based on the setup values entered by the Tournament Captain at tournament startup. This message includes the groupings, player order, and handicaps if applicable for the first round in the tournament. An example of this pre-round message is shown in Table 6. Note that asterisks are used to show holes where players receive handicap strokes.

TABLE 6
Example of Pre-Round Message Attachment for the First Round

| | Round: Round 1 | | | | | | | | | | | Course: My Course #1 | | | | | | | | | | |
|---|---|---|---|---|---|---|---|---|---|---|---|---|---|---|---|---|---|---|---|---|---|---|
| | Hole | 1 | 2 | 3 | 4 | 5 | 6 | 7 | 8 | 9 | OUT | 10 | 11 | 12 | 13 | 14 | 15 | 16 | 17 | 18 | IN | TOTAL |
| | Par | 4 | 4 | 5 | 3 | 4 | 4 | 4 | 3 | 5 | 36 | 4 | 3 | 4 | 4 | 4 | 5 | 3 | 5 | 4 | 36 | 72 |
| Player | HDCP | 11 | 17 | 9 | 13 | 1 | 7 | 3 | 15 | 5 | | 2 | 18 | 14 | 10 | 12 | 6 | 16 | 8 | 4 | | |
| Schmidt, Steve | 9 | | | * | | * | * | * | | * | | * | | | | | * | | * | * | | |
| Johnson, Martha | 18 | * | * | * | * | * | * | * | * | * | | * | * | * | * | * | * | * | * | * | | |
| Roosevelt, Teddy | 3 | | | | | * | | * | | | | * | | | | | | | | | | |
| Duke, Sam | 6 | | | | | * | | * | | * | | * | | | | * | * | | | * | | |
| Wright, Larry | 15 | * | | * | * | * | * | * | * | * | | * | | * | * | * | * | | * | * | | |
| Adams, John | 12 | * | | * | | * | * | * | | * | | * | | | * | * | * | | * | * | | |
| Washington, George | 9 | | | * | | * | * | * | | * | | * | | | | | | | * | * | | |
| Jefferson, Thomas | 1 | | | | | * | | | | | | | | | | | | | | | | |

### Demonstration Use Cases—Start of Round 1

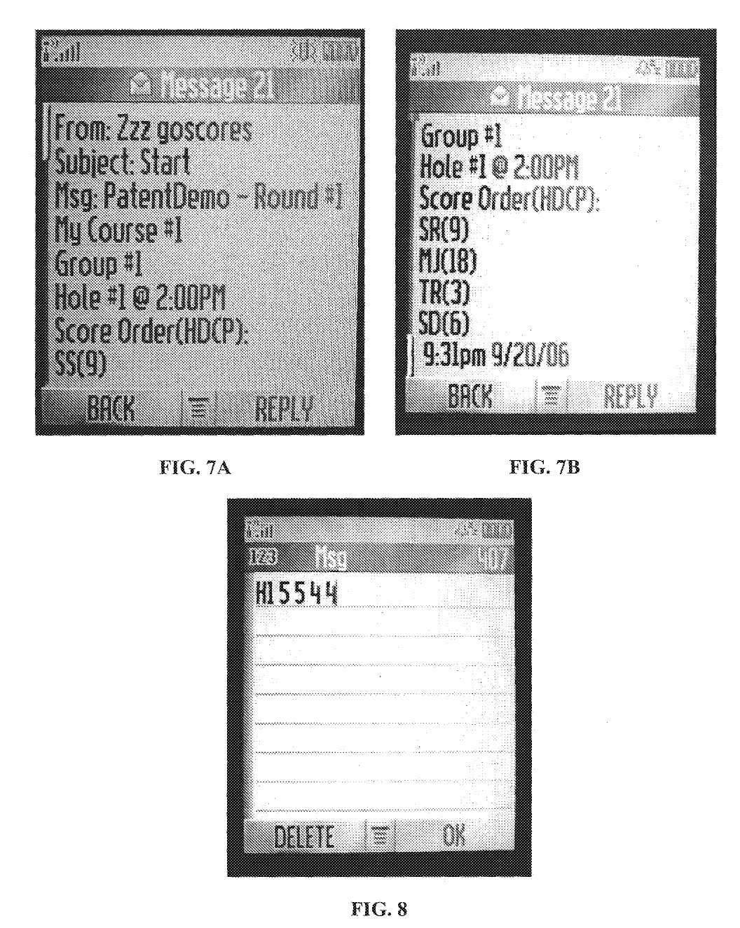

The System uses the tee time values supplied in the tournament setup to initiate a round. The System sends a message to each group's registered scorekeeper prior to the tee time. The default time is 30 minutes prior to the tee time, but the Tournament Captain can configure this value during tournament setup. An example of this startup message for the first round of the demonstration tournament is shown in FIGS. 7A and 7B (note that 2 screenshots are needed to show the entire message after scrolling.)

The Registered Scorekeeper is sent a message containing the round and group information for his or her group. Most importantly, the message specifies the input order expected for the players in the group. This allows the Registered Scorekeeper to enter score and statistics without having to specify the actual golfer with each input message. The order of golfers for the group participating in this demonstration is as follows: SR, MJ, TR, and SD. The ‘short names’ for the golfers are used to save space on the device screen display. The handicap for each golfer is included when the games that are being played include handicap calculations. Other games and display options are available through the setup process based on tournament captain preference and device display capabilities. Please note in this demonstration that the text communication message was sent ahead of the actual tee time by a considerable period of time. The message distribution for an actual playing scenario would be closer to the actual time of play.

### Demonstration Use Cases—Input, Verification, and Standings Distribution

As a group finishes play on a hole, the Registered Scorekeeper creates a text communication message to input the group's scores into the System. Various options are allowed as part of the input for specifying particulars about the scores. These options are outlined in the System interaction instructions. One option is the specification of the hole number for which the scores are to be assigned. For instance, specifying “H1” as part of the input message indicates the scores are to be associated to Hole #1.

### Hole #1

An example of the input for Hole #1 is specified in FIG. 8. This example is specifying an input message to record scores for Hole #1 as follows:

| Player | Score |
|---|---|
| SR | 5 |
| MJ | 5 |
| TR | 4 |
| SD | 4 |

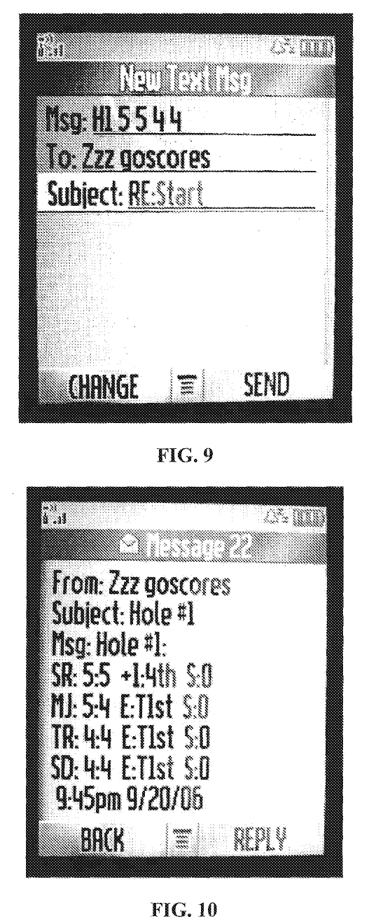

The Registered Scorekeeper then sends the message to the System. An option of creating and sending this message is to reply to a message previously received by the System. FIG. 9 shows an example where the Registered Scorekeeper replied to the “Start” message to input the group scores for Hole #1. The System will receive the message and record the scores. This occurs as each message is received from the Registered Scorekeeper of each group within a round and tournament. A reply message is returned by the System that includes: the hole to which the scores were recorded, the score received for each player, a net score for each player based on handicap, game standings for each player, and game standings for the entire round.

An example of that reply message is displayed in FIG. 10. This message shows the scores that were received for Hole #1 (5, 5, 4, & 4) respectively, along with the net scores based on handicap values. Note that MJ is the only golfer to receive a handicap stroke on Hole #1, hence the indication of 5 net 4 (“5:4”). The total net score and the leaderboard places for each player are listed. This example shows that SR is 4^{th} at 1 over par (“+1:4^{th}”) and the 3 other golfers are even and tied for first place (“E:T1st”). The round also includes a skins game, but no skins have yet to be won by any player (“S:0”).

### Hole #2

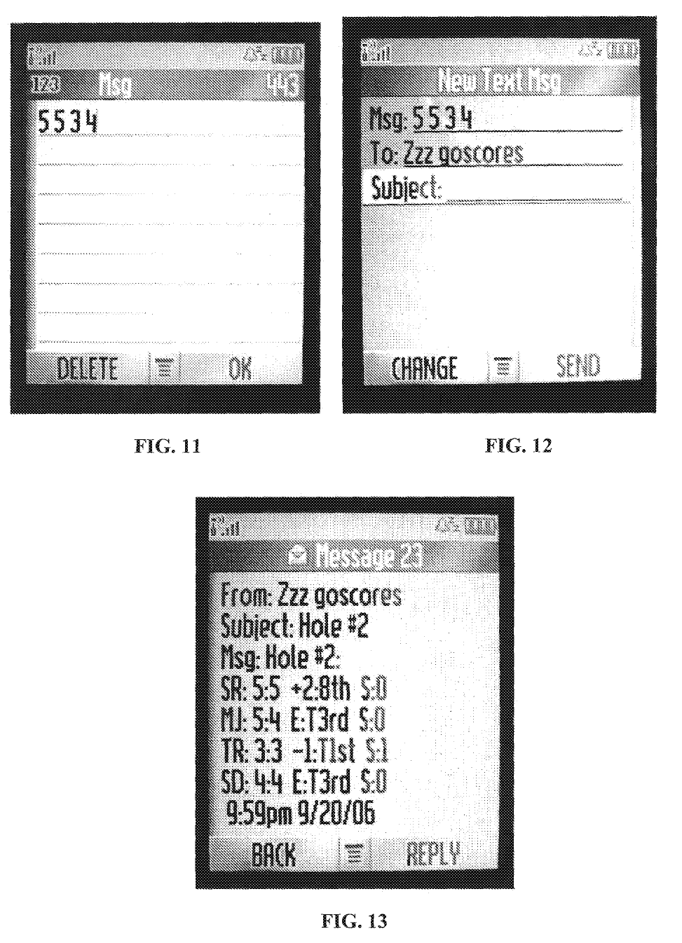

The Registered Scorekeeper continues to send text communication input messages for all holes in the round. FIG. 11 shows an example where the player creates an input message for the scores on the second hole. FIG. 11 shows the score input values, while FIG. 12 shows the messages when it is ready to send, including the contact for the System. The System again records the scores input from the Registered Scorekeeper. Note that in this example, the hole number is not specified. An option for score input is to use the next hole number based on prior input messages received from the Registered Scorekeeper or the start hole for the group. For instance, since the System has received an input message for Hole #1, it will by default apply the next set of scores to Hole #2.

The System returns the reply message, again including the hole to which the scores were recorded, the score received a net score based on handicap, game standings for each player, and game standings for the entire round. An example of that reply message is displayed in FIG. 13. The message in FIG. 13 shows the scores that were received for Hole #2 (5, 5, 3, & 4) respectively, along with the net scores based on handicap values. Note again that MJ is the only golfer to receive a handicap stroke on Hole #2, hence the indication of 5 net 4 (“5:4”). The total net score and the leaderboard places for each player are listed. Note in this response that SR is now in 8^{th} place at 2 over par (“+2:8^{th}”) and that TR is still tied for a share of the lead at 1 under par (“−1:T1st”). This is because other groups in the round have started to post their scores through their Registered Scorekeeper, allowing the results for all groups to be based on all scores received for the round and tournament. Notice on this hole that TR had the low score in this group, therefore, TR currently has a skin (“S:1”). However, this can change as other groups play the hole and possible tie or beat the score posted by TR.

### Hole #3

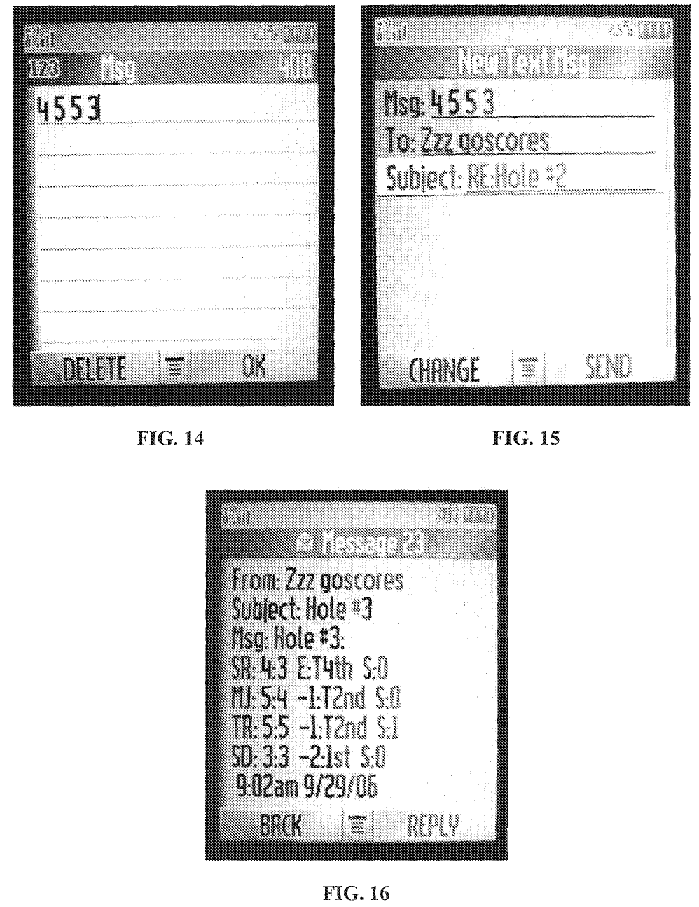

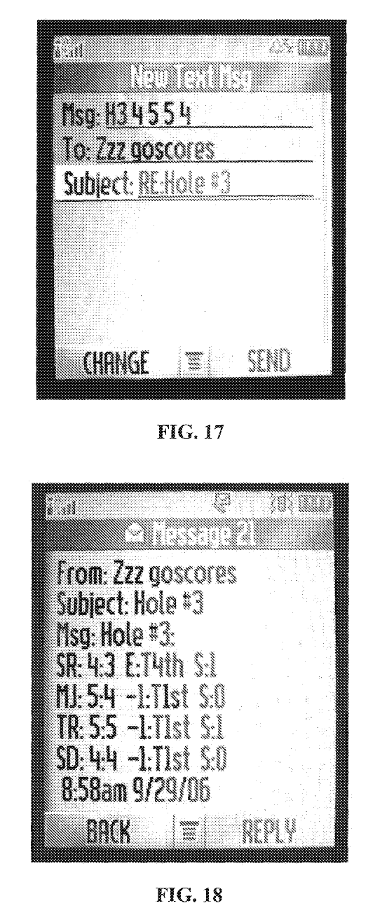

The next example shows the input and reply messages for Hole #3 (FIGS. 14, 15 and 16) and the ability to correct mistakes on prior input (FIG. 17). FIG. 14 shows the example where the Registered Scorekeeper responds to the reply message sent by the System for Hole #2. The input message just supplies the scores of 4, 5, 5, & 3 with the expectation that the System will record the scores for the next hole, Hole #3. The System records the scores as input and sends the reply message shown in FIG. 16 for Hole #3. Note that the standings and skins are automatically updated with the new scores input for Hole #3.

### Correction to Scores for Hole #3

The Registered Scorekeeper then realizes that the score send for SD should have been ‘4’ instead of ‘3’. The Registered Scorekeeper must resend the input message for Hole #3, but must also specify the hole number as part of the message. Without the hole number, the System would record the “corrected scores” for the next hole, Hole #4. An example of this input is displayed in FIG. 17. The System overwrites the previous set of scores recorded for the group with the new set sent in the “corrected” message. The System again returns a subsequent reply message to the Registered Scorekeeper based on the new scores. An example of this reply message is shown in FIG. 18. Note that the totals for the leaderboard are updated with the new score value provided in the score correction message. There is now a 3-player tie for 1^{st} place and SR is credited with a skin for the net low score on the hole.

### Scores for Remaining Holes in Round 1

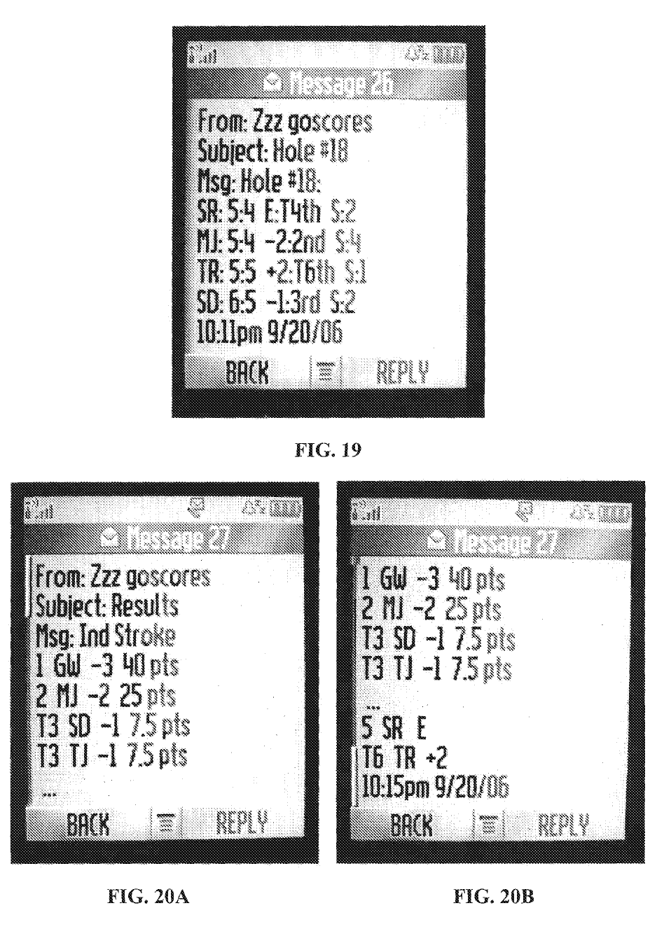

This pattern of input and reply messages continues for the duration of the round. For completeness, this demonstration includes the input scores and reply message for the 18^{th} hole as displayed in FIG. 19. While the scores are now all recorded for this group, it is still possible for the final standings to be different than the last reply message sent by the System for input messages from this group. As other groups complete their rounds and input their scores, the overall results can change.

Other input capabilities include supplying multiple scores for players in a single message. This type of input would be used when a group in the round or tournament does not have access to a text communication device during play. One example is that the group turns in a final scorecard to the Tournament Captain, who then enters the scores for the players in the group. This method will still allow the System to calculate round and tournament standings, however, it will not allow the System to provide real-time scoring during play.

### Final Standings for Round 1

Once the scores for all groups are recorded for all holes, the System will distribute the final standings for the round. Text communication messages are sent to all Registered Scorekeepers for all games played in the round. These messages will include the round result information for each game that is player in the round. The information can include but is not limited to listing all players that receive points for the game along with the finishing place for all golfers in each Registered Scorekeeper's round. Examples of these round result messages are shown in FIGS. 20A-B and 21A-B.

The screenshots in FIGS. 20A and 20B show the round results for the game that was played based on individual Strokes using net handicap scores. GW won first place with a score of 3 under par earning 40 points for the win (“1 GW −3 40 pts”). MJ finish the round in second place with a score of 2 under par earning 25 points (“2 MJ −2 25 pts”). SD and TJ tied for third place in the round with a score of 1 under par, splitting the allotted 15 points (“T3 SD −1 7.5 pts”; “T3 TJ −1 7.5 pts”).

Scrolling through the message (in the screenshot in FIGS. 20A-20B) shows the final results for the remainder of the golfers in the group. The screenshot example in FIGS. 20A-20B was sent to the Registered Scorekeeper for Group 1, therefore, those golfers in that group not listed in the points are also included. This shows that SR finished 5^{th} with a score of even par (“5 SR E”) and TR finished tied for 6^{th} at 2 over par (“T6 TR +2”).

The screenshots in FIGS. 21A-21B show the round results for the game that was played based on Individual Skins using net handicap scores. And 80 points were applied to the game, therefore, that total will be shared across the 12 skins won by the six different players. MJ won a total of 4 skins for 26.67 points (“MJ S:4 26.67 pts”). SD, SR, and TJ all finished with two skins totaling 13.33 points each (“SD S:2 13.33 pts”; “SR S:2 13.33 pts”; “TJ S:2 13.33 pts”). Scrolling through the message shows that both GW and TR ended up with one skin each earning 6.67 points (“GW S:1 6.67 pts”; “TR S:1 6.67 pts”). Final results are not included for any other players since all players not listed finished with zero skins.

The scorecard that was distributed at the start of the tournament is updated with all of the round scores and final results and redistributed as an attachment to a message. An example of this scorecard is displayed in Table 7.

TABLE 7
Example of Final Results Scorecard for First Round

| | Round: Round 1 | | | | | | | | | | | Course: My Course #1 | | | | | | | | | | |
|---|---|---|---|---|---|---|---|---|---|---|---|---|---|---|---|---|---|---|---|---|---|---|
| | Hole | 1 | 2 | 3 | 4 | 5 | 6 | 7 | 8 | 9 | OUT | 10 | 11 | 12 | 13 | 14 | 15 | 16 | 17 | 18 | IN | TOTAL |
| | Par | 4 | 4 | 5 | 3 | 4 | 4 | 4 | 3 | 5 | 36 | 4 | 3 | 4 | 4 | 4 | 5 | 3 | 5 | 4 | 36 | 72 |
| Player | HDCP | 11 | 17 | 9 | 13 | 1 | 7 | 3 | 15 | 5 | | 2 | 18 | 14 | 10 | 12 | 6 | 16 | 8 | 4 | | |
| Adams, John | 12 | 4/3 | 5/5 | 5/4 | 4/4 | 6/5 | 6/5 | 4/3 | 4/4 | 6/5 | 44/38 | 4/3 | 3/3 | 5/5 | 5/4 | 4/3 | 7/6 | 3/3 | 6/5 | 5/4 | 42/36 | 86/74 |
| Duke, Sam | 6 | 4/4 | 4/4 | 4/4 | 4/4 | 5/4 | 4/4 | 4/3 | 3/3 | 5/4 | 37/34 | 6/5 | 4/4 | 4/4 | 4/4 | 4/4 | 5/4 | 2/2 | 5/5 | 6/5 | 40/37 | 77/71 |
| Jefferson, | 1 | 5/5 | 4/4 | 5/5 | 3/3 | 5/4 | 4/4 | 4/4 | 3/3 | 5/5 | 38/37 | 4/4 | 3/3 | 4/4 | 3/3 | 3/3 | 5/5 | 4/4 | 5/5 | 3/3 | 34/34 | 72/71 |
| Thomas | | | | | | | | | | | | | | | | | | | | | | |
| Johnson, Martha | 18 | 5/4 | 5/4 | 5/4 | 3/2 | 6/5 | 6/5 | 6/5 | 5/4 | 6/5 | 47/38 | 5/4 | 3/2 | 5/4 | 5/4 | 5/4 | 4/3 | 4/3 | 5/4 | 5/4 | 41/32 | 88/70 |
| Roosevelt, Teddy | 3 | 4/4 | 3/3 | 5/5 | 3/3 | 5/4 | 4/4 | 4/3 | 3/3 | 5/5 | 36/34 | 5/4 | 4/4 | 4/4 | 5/5 | 4/4 | 5/5 | 3/3 | 6/6 | 5/5 | 41/40 | 77/74 |
| Schmidt, Steve | 9 | 5/5 | 5/5 | 4/3 | 4/4 | 6/5 | 5/4 | 5/4 | 4/4 | 6/5 | 44/39 | 5/4 | 3/3 | 3/3 | 4/4 | 4/4 | 5/4 | 3/3 | 5/4 | 5/4 | 37/33 | 81/72 |
| Washington, | 9 | 4/4 | 5/5 | 4/3 | 3/3 | 5/4 | 4/3 | 5/4 | 4/4 | 6/5 | 40/35 | 4/3 | 4/4 | 4/4 | 4/4 | 3/3 | 6/5 | 3/3 | 5/4 | 5/4 | 38/34 | 78/69 |
| George | | | | | | | | | | | | | | | | | | | | | | |
| Wright, Larry | 15 | 5/4 | 6/6 | 6/5 | 4/3 | 6/5 | 6/5 | 5/4 | 4/3 | 5/4 | 47/39 | 4/3 | 4/4 | 5/4 | 5/4 | 5/4 | 6/5 | 4/4 | 6/5 | 5/4 | 44/37 | 91/76 |

| | | |
|---|---|---|
| Individual Stroke Winners | Score | Points |
| Washington, George | −3 | 40.0 |
| Johnson, Martha | −2 | 25.0 |
| Duke, Sam | −1 | 7.5 |
| Jefferson, Thomas | −1 | 7.5 |

| | | |
|---|---|---|
| Individual Skin Winners | Quantity | Points |
| Johnson, Martha | 4 | 26.67 |
| Duke, Sam | 2 | 13.33 |
| Jefferson, Thomas | 2 | 13.33 |
| Schmidt, Steve | 2 | 13.33 |
| Roosevelt, Teddy | 1 | 6.67 |
| Washington, George | 1 | 6.67 |

### Demonstration Use Cases Round 2

If additional rounds are scheduled for the tournament, the System prepares for the start of the next round. Additional rounds can occur on the same day or at some day in the future. Handicaps are updated if required for use in the next round. The System will distribute a pre-round message, with an attached spreadsheet, that shows the setup for the second round. Similar to the pre-round message sent for Round 1, this message includes the groupings, player order, and newly updated handicaps if applicable for the round. An example of this message is shown in Table 8.

TABLE 8
Example of Pre-Round Message Attachment for the Second Round

| | Round: Round 2 | | | | | | | | | | | Course: My Course #2 | | | | | | | | | | |
|---|---|---|---|---|---|---|---|---|---|---|---|---|---|---|---|---|---|---|---|---|---|---|
| | Hole | 1 | 2 | 3 | 4 | 5 | 6 | 7 | 8 | 9 | OUT | 10 | 11 | 12 | 13 | 14 | 15 | 16 | 17 | 18 | IN | TOTAL |
| | Par | 5 | 4 | 4 | 4 | 3 | 5 | 4 | 3 | 4 | 36 | 4 | 4 | 3 | 5 | 4 | 4 | 5 | 3 | 4 | 36 | 72 |
| Player | HDCP | 7 | 17 | 9 | 5 | 1 | 11 | 3 | 13 | 15 | | 10 | 4 | 14 | 2 | 12 | 6 | 18 | 8 | 16 | | |
| Schmidt, Steve | 9 | * | | * | * | * | | * | | | | | * | | * | | * | | * | | | |
| Roosevelt, Teddy | 5 | * | * | * | * | * | * | * | * | * | | * | * | * | * | * | * | * | * | * | | |
| Wright, Larry | 18 | * | * | * | * | * | * | * | * | * | | * | * | * | * | * | * | * | * | * | | |
| Washington, George | 5 | | | | * | * | | * | | | | | * | | * | | | | | | | |
| Johnson, Martha | 16 | * | | * | * | * | * | * | * | * | | * | * | * | * | * | * | | * | * | | |
| Duke, Sam | 5 | | | | * | * | | * | | | | | * | | * | | | | | | | |
| Adams, John | 13 | * | | * | * | * | * | * | * | | | * | * | | * | * | * | | * | | | |
| Jefferson, Thomas | 1 | | | | | * | | | | | | | | | | | | | | | | |

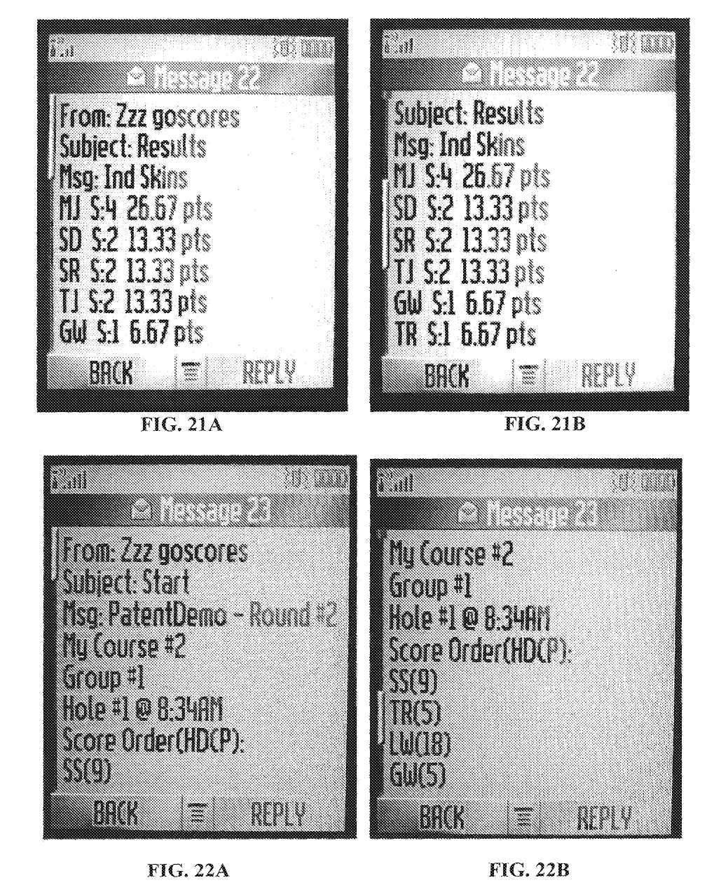

The System again uses the tee time values supplied in the tournament setup to initiate a round. The System sends a message to each group's registered scorekeeper prior to the tee time. An example of this startup message for the second round of the demonstration tournament is shown in FIGS. 22A and 22B (note that 2 screenshots are needed to show the entire message after scrolling.) This message contains the round and group information for the group within which the registered scorekeeper is included for the second round. Most importantly again, the message specifies the input order the System expects for the players in the group. This allows the Registered Scorekeeper to enter score and statistics without having to specify the actual golfer with each input message. The order of golfers for the group participating in this demonstration is as follows: SR, TR, LW, and GW. The handicap for each golfer since this round includes games that are being played using net score calculations with handicap. Please note again in this demonstration that the text communication message was sent ahead of the actual tee time by a considerable period of time. The message distribution for an actual playing scenario would be closer to the actual time of play.

The Registered Scorekeepers again enter the scores for the second round as each hole is played and the System responds with the leaderboard standings throughout the round. At the end of the second round, the System will again distribute text communication messages identifying game winners and a spreadsheet type listing with the round results. At the end of the second round, a tournament total is also included as part of the distribution. An example of the second round results with total tournament standings is shown in Table 9.

TABLE 9
Example of Results Scorecard for Second Round

| | Round: Round 2 | | | | | | | | | | | Course: My Course #2 | | | | | | | | | | |
|---|---|---|---|---|---|---|---|---|---|---|---|---|---|---|---|---|---|---|---|---|---|---|
| | Hole | 1 | 2 | 3 | 4 | 5 | 6 | 7 | 8 | 9 | OUT | 10 | 11 | 12 | 13 | 14 | 15 | 16 | 17 | 18 | IN | TOTAL |
| | Par | 5 | 4 | 4 | 4 | 3 | 5 | 4 | 3 | 4 | 36 | 4 | 4 | 3 | 5 | 4 | 4 | 5 | 3 | 4 | 36 | 72 |
| Player | HDCP | 7 | 17 | 9 | 5 | 1 | 11 | 3 | 13 | 15 | | 10 | 4 | 14 | 2 | 12 | 6 | 18 | 8 | 16 | | |
| Adams, John | 13 | 6/5 | 5/5 | 5/4 | 4/3 | 6/5 | 6/5 | 4/3 | 4/3 | 6/6 | 46/39 | 4/3 | 4/3 | 4/4 | 5/4 | 4/3 | 7/6 | 3/3 | 6/5 | 5/5 | 42/36 | 88/75 |
| Duke, Sam | 5 | 4/4 | 4/4 | 4/4 | 4/3 | 5/4 | 4/4 | 4/3 | 3/3 | 5/5 | 37/34 | 6/6 | 4/3 | 4/4 | 4/3 | 4/4 | 5/5 | 4/4 | 5/5 | 5/5 | 41/39 | 78/73 |
| Jefferson, | 1 | 5/5 | 4/4 | 5/5 | 3/3 | 5/4 | 4/4 | 4/4 | 3/3 | 4/4 | 37/36 | 4/4 | 3/3 | 4/4 | 3/3 | 3/3 | 5/5 | 4/4 | 5/5 | 3/3 | 34/34 | 71/70 |
| Thomas | | | | | | | | | | | | | | | | | | | | | | |
| Johnson, Martha | 16 | 5/4 | 5/5 | 5/4 | 3/2 | 6/5 | 6/5 | 6/5 | 5/4 | 6/5 | 47/39 | 5/4 | 3/2 | 5/4 | 5/4 | 5/4 | 4/3 | 5/5 | 5/4 | 5/4 | 42/34 | 89/73 |
| Roosevelt, Teddy | 5 | 4/4 | 3/3 | 5/5 | 3/2 | 5/4 | 4/4 | 4/3 | 3/3 | 5/5 | 36/33 | 5/5 | 4/3 | 4/4 | 5/4 | 4/4 | 5/5 | 3/3 | 6/6 | 5/5 | 41/39 | 77/72 |
| Schmidt, Steve | 9 | 5/4 | 5/5 | 4/3 | 4/3 | 6/5 | 5/5 | 5/4 | 4/4 | 6/6 | 44/39 | 5/5 | 3/2 | 3/3 | 4/3 | 4/4 | 5/4 | 3/3 | 5/4 | 5/5 | 37/33 | 81/72 |
| Washington, | 5 | 4/4 | 5/5 | 4/4 | 3/2 | 5/4 | 4/4 | 5/4 | 4/4 | 6/6 | 40/37 | 4/4 | 4/3 | 4/4 | 4/3 | 3/3 | 6/6 | 3/3 | 5/5 | 5/5 | 38/36 | 78/73 |
| George | | | | | | | | | | | | | | | | | | | | | | |
| Wright, Larry | 18 | 5/4 | 6/5 | 6/5 | 4/3 | 6/5 | 6/5 | 5/4 | 4/3 | 5/4 | 47/38 | 4/3 | 4/3 | 5/4 | 5/4 | 5/4 | 6/5 | 4/3 | 6/5 | 5/4 | 44/35 | 91/73 |

| | | |
|---|---|---|
| Individual Stroke Winners | Score | Points |
| Jefferson, Thomas | −2 | 40.0 |
| Roosevelt, Teddy | E | 20.0 |
| Schmidt, Steve | E | 20.0 |

| | | |
|---|---|---|
| Individual Skin Winners | Quantity | Points |
| Schmidt, Steve | 2 | 32.00 |
| Jefferson, Thomas | 1 | 16.00 |
| Johnson, Martha | 1 | 16.00 |
| Roosevelt, Teddy | 1 | 16.00 |

| | |
|---|---|
| Total Tournament Standings | Points |
| 1-Jefferson, Thomas | 76.83 |
| 2-Johnson, Martha | 67.67 |
| 3-Schmidt, Steve | 65.33 |
| 4-Washington, George | 46.67 |
| 5-Roosevelt, Teddy | 42.67 |
| 6-Duke, Sam | 20.83 |

Once all rounds of the tournament have been completed, the System marks the tournament as complete. This is done to allow the Tournament Captain to host additional tournaments in the future. Tournament completion also allows the Registered Scorekeepers to perform that role in future tournaments, as well.

Once a tournament has been marked completed by the System, only the Tournament Captain is allowed to make additional modifications to the input values. Any additional modifications by the Tournament Captain will result in recalculations by the System. The recalculated results will be distributed to the Tournament Captain. The results of the tournament are also available to the Tournament Captain for use in calculating player handicaps for future tournaments. Options are also available to allow other tournament players to have access to their score and result data based on System membership status.

The above described system and method provide a number of features, including the following.

Providing an automated system that collects golf tournament, round, player, score and statistic information via text communication methods, then calculates and distributes standings, railings, and points to players and spectators. The collection and distribution of information occurs in a near-real-time fashion via commonly available text communication methods. Referred hereafter as the Automated System.

Providing methods that allow users to enter scores and statistics for the Automated System via commercially available text communication methods. These methods are accessed by the user through user owned CPE devices.

Providing a Communications Center that receives text communication input to the Automated System for collecting scores and statistics. A Custom User Interface application that can be downloaded and executed on an end-user device. This application allows for the input of golf score, standings, and statistics, then automatically generates text communication messages to travel over text communication channels.

Providing a Communications Center that receives text communication input to the Automated System that interprets requests for standings and statistics. A Custom User Interface application that can be downloaded and executed on an end-user device. This application allows the user to request standings, scoring, and statistic data from the Communication Center by automatically generating text communication messages that travel to the central communications center over text communication channels.

Providing a Communications Center that creates text communication messages for distributing standings and statistics from the Automated System. A Custom User Interface application that can be downloaded and executed on an end-user device. This application automatically converts standings and statistics embedded in text communication messages from the Communication Center into a user interface form for display.

Providing a communications center that receives text communication requests to the Automated System for real-time scores, standings, and statistics via electronic messaging.

Providing information distribution that can automatically, or upon request, send scores, standings, and statistics from the Automated System via electronic messaging. Providing administration access to allow users to set up and administer tournaments and rounds in the Automated System for real-time scoring and statistics via electronic messaging and online access.

Providing online and electronic messaging content concerning tournament and round standings and statistics from the Automated System.

Providing online and electronic messaging content from the Automated System concerning player standings and statistics, including historical information.

Providing distributed content from the Automated System concerning tournament and round standings and statistics via electronic messaging.

Permitting a user to selectively identify permitted access to the Automated System in order to input scores and/or view tournament and round standings.

Permitting a user to selectively invite other users to join a tournament and/or round which has been entered into the Automated System.

Permitting a user to accept an invitation or request from another user to join a tournament and/or round which has been entered into the Automated System.

Providing distributed text communication (e.g. email) readouts of player standings and statistics during and at the completion of rounds and tournaments.

Providing a method for setting up tournaments and rounds via text communication methods.

Providing text communication methods that permit the tournament captain to chose from a select list of games during tournaments and round setup.

Providing an Automated System that maintains handicaps, settings, scores, and statistics that automatically uses this data for future rounds and tournaments. Text exchange and convergence between fixed and mobile endpoints to create a seamless, any-time application.

An automated system that calculates tournament and round information from input data, then applies that data forward automatically to future rounds and tournaments. An example being that the system can generate a golf handicap based on data from a current round then automatically apply that new handicap to a future round or tournament.

Providing real-time notifications of tee time, group pairings, hole start number, game type, etc. for tournaments and rounds.

While the foregoing written description of the invention enables one of ordinary skill to make and use what is considered presently to be the best mode thereof, those of ordinary skill will understand and appreciate the existence of variations, combinations, and equivalents of the specific exemplary embodiment and method herein. The invention should therefore not be limited by the above described embodiment and method, but by all embodiments and methods within the scope and spirit of the invention as claimed.

What is claimed is:

1. A system for administrating user preferences, capabilities, and subscription, comprising:
an automated server that collects information from a user via text communication, and calculates and distributes data derived from said information to said user via text communication;
so that collection and distribution of information and data occurs in a near-real-time fashion via commonly available text communication methods,

2. The system of claim 1, wherein said information comprises subscription and membership descriptions and signup information.

3. The system of claim 1, wherein said server further maintains user member id and password information.

4. A system for administrating tournaments and rounds, comprising:
an automated server that collects tournament, round, player, score and statistic information from a user via text communication, and calculates and distributes standings, rankings, and points data derived from said information to players and spectators via text communication;
so that collection and distribution of information and data occurs in a near-real-time fashion via commonly available text communication methods.

5. The system of claim 4, wherein said server further allows users to enter scores and statistics for the server via commercially available text communication methods, including user owned CPE devices.

6. The system of claim 4, and further including a communications center that receives text communication from a user for input to the server.

7. The system of claim 4, wherein said server hosts a custom user interface application that can be downloaded and executed on an end-user device, and wherein said custom user interface application allows for the input of golf score, standings, and statistics, then automatically generates text communication messages to travel over text communication channels.

8. The system of claim 7, and further including a communications center that receives text communication from a user for input to the server.

9. The system of claim 8, wherein said communications center creates text communication messages for distributing standings and statistics from the server to a user.

10. The system of claim 9, wherein the server hosts a custom user interface application that can be downloaded and executed on an end-user device, and wherein said custom user interface application automatically converts standings and statistics embedded in text communication messages from the communication center into a user interface form for display.

11. The system of claim 4, and further including a communications center that receives text communication input to the server that interprets requests for standings and statistics.

12. The system of claim 4, and further including a communications center that receives text communication requests from a user to the server for real-time scores, standings, and statistics via text communication messaging.

13. The system of claim 4, wherein said server further provides for information distribution that can automatically, or upon request, send scores, standings, and statistics from the server via, text communication messaging.

14. The system of claim 4, wherein said server provides administration access to allow users to set up and administer tournaments and rounds for real-time scoring and statistics via electronic messaging and online access.

15. The system of claim 4, wherein said server provides online and text messaging content concerning tournament and round standings and statistics.

16. The system of claim 4, wherein said server provides online and text messaging content concerning player standings and statistics, including historical information.

17. The system of claim 4, wherein said server provides distributed content concerning tournament and round standings and statistics via text messaging.

18. The system of claim 4, wherein said server permits a user to selectively identify permitted access to the server in order to input scores and/or view tournament and round standings.

19. The system of claim 4, wherein said server permits a user to selectively invite other users to join a tournament and/or round which has been entered into the server.

20. The system of claim 4, wherein said server permits a user to accept an invitation or request from another user to join a tournament and/or round which has been entered into the Automated System.

21. The system of claim 4, wherein said server provides distributed text communication readouts of player standings and statistics during and at the completion of rounds and tournaments.

22. The system of claim 4, wherein said server provides a method for setting up tournaments and rounds via text communication methods.

23. The system of claim 4, wherein said server permits a tournament captain to choose from a select list of games during tournaments and round setup.

24. The system of claim 4, wherein said server maintains handicaps, settings, scores, and statistics that automatically uses this data for future rounds and tournaments.

25. The system of claim 4, wherein said server permits text exchange and convergence between fixed and mobile endpoints to create a seamless, any-time application.

26. The system of claim 4, wherein said server further applies said tournament and round information forward automatically to future rounds and tournaments, including generating a golf handicap based on data from a current round then automatically applying said handicap to a future round or tournament.

27. The system of claim 4, wherein said server provides real-time notifications of tee time, group pairings, hole start number, and game type for tournaments and rounds.

28. A system for administrating tournaments and rounds, comprising:
an automated server that collects tournament, round, player, score and statistic information via text communication, that calculates tournament and round information from input data, then applies said tournament and round information forward automatically to future rounds and tournaments, and distributes said tournament and round information to players and spectators via text communication;
wherein said automated server distributes said data derived from said information to a user via text communication,
so that collection and distribution of information and data occurs in a near-real-time fashion via commonly available text communication methods.

29. The system of claim 28, wherein said calculating and distributing include generating a golf handicap based on data from a current round then automatically applying that new handicap to a future round or tournament.

30. A method for administrating tournaments and rounds, comprising:
an automated server collecting tournament, round, player, score and statistic information via text communication, calculating and distributing standings, rankings, and points data derived from said information to players and spectators via text communication;
a user sending said information to said automated server in a text communication format;
said automated server further distributing said data derived from said information to a user device via text communication, so that collection and distribution of information and data occurs in a near-real-time fashion via commonly available text communication methods.

31. The method of claim 30, said automated server further providing methods that allow users to enter scores and statistics via commercially available text communication methods, including user owned CPE devices.

32. The method of claim 30, said automated server further providing a custom user interface application that can be downloaded and executed on an end-user device, for the inputting of golf score, standings, and statistics, then automatically generates text communication messages to travel over text communication channels.

33. The method of claim 30, and further including downloading a custom user interface application from said server to an end-user device, and executing said custom user interface application on said end-user device,

34. The method of claim 33, wherein said executing includes requesting standings, scoring, and statistic data by automatically generating text communication messages that travel over text communication channels.

35. The method of claim 30, and further including a communications center receiving text communication requests to the server for real-time scores, standings, and statistics via electronic messaging.

36. The method of claim 30, and further including said server providing information distribution that can automatically, or upon request, send scores, standings, and statistics via electronic messaging.

37. The method of claim 30, and further including said server providing administration access to allow users to set up and administer tournaments and rounds for real-time scoring and statistics via electronic messaging and online access.

38. The method of claim 30, and further including said server providing online and electronic messaging content concerning tournament and round standings and statistics from the Automated System.

39. The method of claim 30, and further including said server providing online and electronic messaging content concerning player standings and statistics, including historical information.

40. The method of claim 30, and further including said server providing distributed content concerning tournament and round standings and statistics via electronic messaging.

41. The method of claim 30, and further including said server permitting a user to selectively identify permitted access to the server in order to input scores and/or view tournament and round standings.

42. The method of claim 30, and further including said serve, permitting a user to selectively invite other users to join a tournament and/or round which has been entered into the server.

43. The method of claim 30, and further including said server permitting a user to accept an invitation or request from another user to join a tournament and/or round which has been entered into the server.

44. The method of claim 30, and further including providing distributed text communication readouts of player standings and statistics during and at the completion of rounds and tournaments.

45. The system of claim 30, and further including setting up tournaments and rounds via text communication methods.

46. The method of claim 30, and further including a tournament captain choosing from a select list of games during tournaments and round setup, via text communication methods.

47. The system of claim 30, and further including said server, maintaining handicaps, settings, scores, and statistics, and automatically using this data for future rounds and tournaments.

48. The method of claim 30, and further including said server permitting text exchange and convergence between fixed and mobile endpoints to create a seamless, any-time application.

49. The method of claim 30, and further including said server calculating tournament and round information from input data, and applying that data forward automatically to future rounds and tournaments, including generating a golf handicap based on data from a current round then automatically applying said handicap to a future round or tournament.

50. The method of claim 30 and further including providing real-time notifications of tee time, group pairings, hole start number and game type, for tournaments and rounds.
